(19) United States
(12) Patent Application Publication
(10) Pub. No.: US 2023/0134494 A1
(43) Pub. Date: May 4, 2023

(54) HEAT EXCHANGER AND METHOD OF MANUFACTURING HEAT EXCHANGER

(71) Applicant: HONDA MOTOR CO., LTD., Tokyo (JP)

(72) Inventors: Yasunari KIMURA, Saitama (JP); Hirosumi TODAKA, Saitama (JP)

(21) Appl. No.: 17/937,782

(22) Filed: Oct. 4, 2022

(30) Foreign Application Priority Data
Nov. 1, 2021 (CN) 202111281917.X

(51) Int. Cl. F28F 9/02; B21D 53/04

(52) U.S. Cl. CPC F28F 9/02; B21D 53/04

(57) ABSTRACT

The heat exchanger includes a heat radiation part having an opened outer surface, and frame bodies provided at both ends of the heat radiation part, and the heat radiation part includes a displacement adjuster that functions as a spring element. The heat exchanger is manufactured by additive manufacturing by use of a metal material including forming the displacement adjuster that functions as the spring element integrally with the heat radiation part and forming the frame bodies integrally with both ends of the heat radiation part.

This application is based on and claims the benefit of priority from Chinese Patent Application Ho. 202111281917.x, filed on 1 Nov. 2021, the content of which is incorporated herein by reference.

### BACKGROUND OF THE INVENTION

### Field of the Invention

The present invention relates to a heat exchanger and a method of manufacturing a heat exchanger.

### Related Art

In an engine compartment of a vehicle, a radiator that is a cooler is installed. The radiator includes a heat radiation part having an opened outer surface, and frame bodies provided at both ends of the heat radiation part. The radiator is a heat exchanger that passes a refrigerant through an interior of the heat radiation part via the frame bodies and that performs heat exchange with outside air (see, for example, Patent Document 1).

Patent Document 1: Japanese Patent No. 4934095

### SUMMARY OF THE INVENTION

In general, a heat radiation part has a thin, fine shape for densification, whereas a frame body has a large thickness to ensure strength and rigidity. Therefore, with change in temperature of a heat exchanger, the thin, fine heat radiation part is noticeably thermally expanded and displaced with respect to the frame body and extends and contracts in a length direction of the heat radiation part. At this time, stress is concentrated on a boundary between the heat radiation part and the frame body, and hence countermeasures therefore are required to be taken.

In recent years, additive manufacturing of three-dimensionally additively manufacturing a product by use of a 3D printer has been known. According to the additive manufacturing, it is possible to integrally form a heat radiation part and a frame body into any shape by use of a metal material such as a powder metal or a metal wire. However, when the heat radiation part and the frame body are integrally formed, the heat radiation part and the frame body are continuous, and hence when stress is concentrated on the boundary between the heat radiation part and the frame body with change in temperature of the heat exchanger, cracks might be generated. Additionally, even when thermal strain of a formed product is released after manufacturing, cracks might be generated at the boundary between the heat radiation part and the frame body due to deformation of the heat radiation part. It is also conceivable to form fillets at the boundary and reinforce the boundary, which is not preferable because increase in amount of the metal material for use increases a weight of the heat exchanger.

An object of the present invention is to provide a heat exchanger and a method of manufacturing a heat exchanger capable of suppressing stress concentration on a boundary between a heat radiation part and a frame body.

(1) A heat exchanger according to the present invention is a heat exchanger (for example, an after-mentioned radiator 1) Including a heat radiation part (for example, an after-mentioned heat radiation part 2) having an opened outer surface, and frame bodies (for example, after-mentioned frame bodies 3) provided at both ends of the heat radiation part, and the heat radiation part includes a displacement adjuster (for example, an after-mentioned displacement adjuster 22) that functions as a spring element.

(2) In the heat exchanger according to the above (1), the heat radiation part may be provided continuously with one surface (for example, an after-mentioned heat radiation part connecting surface 3a) of each of the frame bodies, and the displacement adjuster may be arranged at each of both ends of the heat radiation part.

(3) In the heat exchanger according to the above (1) or (2), the displacement adjuster may be formed into a bellows or spiral shape by curving a wail of the heat radiation part.

(4) In the heat exchanger according to any one of the above (1) to (3), the heat radiation part and the frame bodies are integrally formed as an integrally formed product.

(5) In the heat exchanger according to the above (4), the heat radiation part and the frame bodies may be formed as the integrally formed product by additive manufacturing by use of the same metal material.

(6) A method of manufacturing a heat exchanger according to the present invention is a method of manufacturing a heat exchanger (for example, an after-mentioned radiator 1) including a heat radiation part (for example, an after-mentioned heat radiation part 2) having an opened outer surface, and frame bodies (for example, after-mentioned frame bodies 3) provided at both ends of the heat radiation part, the method including, by additive manufacturing by use of a powder metal, forming a displacement adjuster (for example, an after-mentioned displacement adjuster 22) that functions as a spring element integrally with the heat radiation part, and forming the frame bodies integrally with both ends of the heat radiation part.

According to the above (1), thermal expansion displacement of a heat radiation part can be absorbed by elastic deformation of a displacement adjuster, so that stress concentration on a boundary between the heat radiation part and each frame body due to temperature change can be suppressed, and a high-quality heat exchanger in which any cracks are not generated can be provided.

According to the above (2), since the thermal expansion displacement of the heat radiation part can be absorbed in the vicinity of the boundary between the heat radiation part and the frame body, an effect of suppressing stress concentration on the boundary can be further enhanced.

According to the above (3), a displacement adjuster capable of absorbing the thermal expansion displacement of the heat radiation part can be easily formed.

According to the above (4), the heat radiation part and the frame body are formed as an integrally formed product, so that a compact and lightweight heat exchanger can be easily manufactured.

According to the above (5), the heat radiation part, and the frame body can be easily integrally formed using a 3D printer.

According to the above (6), the heat exchanger of high quality can be easily manufactured using the 3D printer, in which the thermal expansion displacement of the heat radiation part can be absorbed by the elastic deformation of the displacement adjuster and the stress concentration on the boundary between the heat radiation part and the frame body due to temperature change can be suppressed.

### BRIEF DESCRIPTION OF THE DRAWINGS

FIG. 1 is a perspective view of a heat exchanger;

FIG. 2 is a perspective view showing an enlarged boundary region between a heat radiation part and a frame body in the heat exchanger;

FIG. 3 is a cross-sectional view showing the enlarged boundary region between the heat radiation part and the frame body in the heat exchanger;

FIG. 4 is a front view showing a position of a displacement adjuster in the heat exchanger; and

FIG. 5 is a front view showing another example of the position of the displacement adjuster in the heat exchanger.

### DETAILED DESCRIPTION OF THE INVENTION

Hereinafter, description will be made as to an embodiment of the present invention with reference to the drawings. A radiator 1 that is a heat exchanger includes a plurality of heat radiation parts 2, frame bodies 3 provided at both ends of each of the heat radiation parts 2, and a plurality of supports 4 provided over two frame bodies 3 and 3.

Each of the heat radiation parts 2 has a long hollow shape the interior of which coolant can flow through and extends linearly along a flowthrough direction of the coolant (an up-down direction in the drawing). The heat radiation part 2 of the present embodiment is made of a flat thin tubular member but may include a tubular member having a circular cross section or the like. The plurality of heat radiation parts 2 are arranged in parallel with one another at regular intervals with flat surfaces facing one another. Between the adjacent heat radiation parts 2 and 2, each of a plurality of thin plate-shaped heat transfer fins 5 made of the same metal material as the heat radiation parts 2 is provided integrally so as to connect both the adjacent heat radiation parts 2 and 2 to each other.

Each of the frame bodies 3 is larger in thickness than the heat radiation part 2 and is formed into a rectangular plate shape extending along an arrangement direction of the plurality of heat radiation parts 2. The frame body 3 has such a size as can cover the whole end of the plurality of arranged heat radiation parts 2. The end of each heat radiation part 2 is provided so as to be continuous with one surface (heat radiation part connecting surface 3a) of the frame body 3.

The term “continuous” means that the metal material forming the heat radiation part 2 and the metal material forming the frame body 3 are directly connected without interposing another member between the materials. The radiator 1 can be formed by integrally forming the heat radiation part 2 and the frame body 3.

In the other, surface (non-heat radiation part connecting surface 3b) of the frame body 3, a recess 31 is provided, the recess having a size to surround a connecting region to the plurality of heat radiation parts 2 on the heat radiation part connecting surface 3a. In a bottom surface 31a of the recess 31, a number of communication ports 32 corresponding to the number of heat radiation parts 2 are formed. The communication ports 32 communicate with respective internal flow paths 21 of the plurality of heat radiation parts 2 connected to the frame bodies 3.

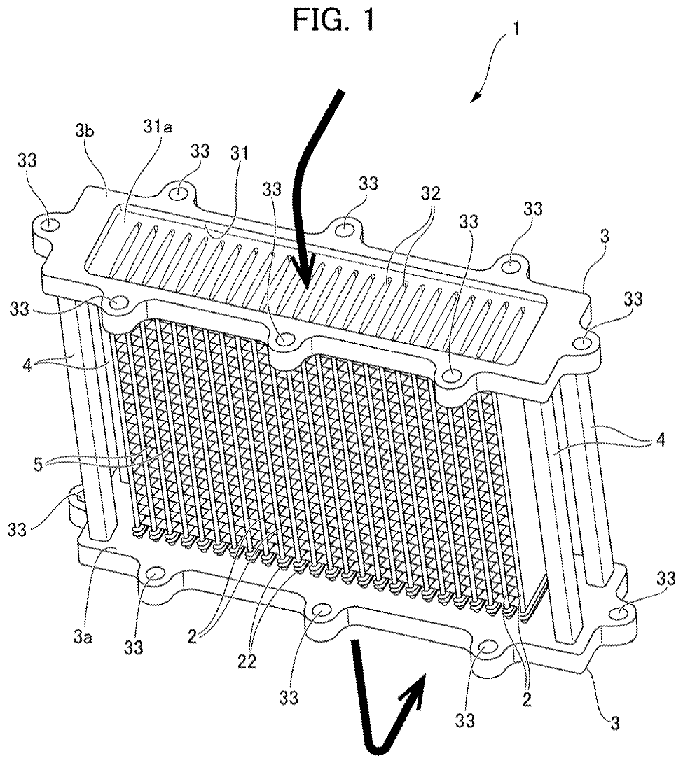

n an outer periphery of the frame body 3, a plurality of mounting holes 33 are formed for bolting flow path members (not shown) to the non-heat radiation part connecting surface 3b of the frame body 3. As shown with arrows in FIG. 1, coolant flows into and out of the radiator 1 via the flow path members (not shown) each mounted on the frame body 3.

The supports 4 are arranged on both outer sides in the arrangement direction of the plurality of heat radiation parts 2, and each support is provided so as to connect two frame bodies 3 and 3 to each other. In the radiator 1, the two frame bodies 3 and 3 are held at a regular interval by the supports 4. The plurality of heat radiation parts 2 and the plurality of heat transfer fins 5 are arranged in an inner space surrounded with two frame bodies 3 and 3 and the plurality of supports 4, and have outer surfaces opened so as to be able to radiate heat in contact with the outside air.

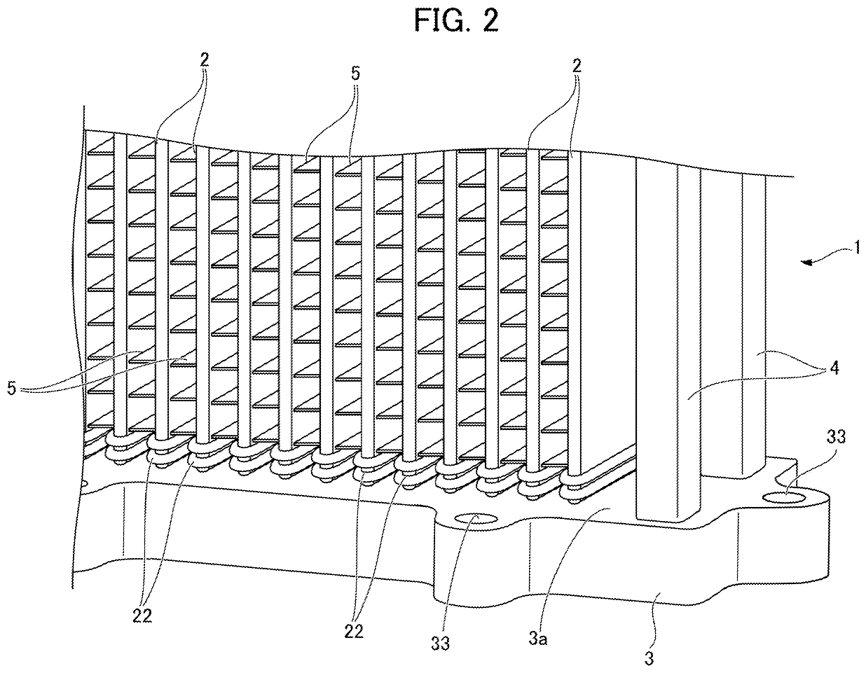

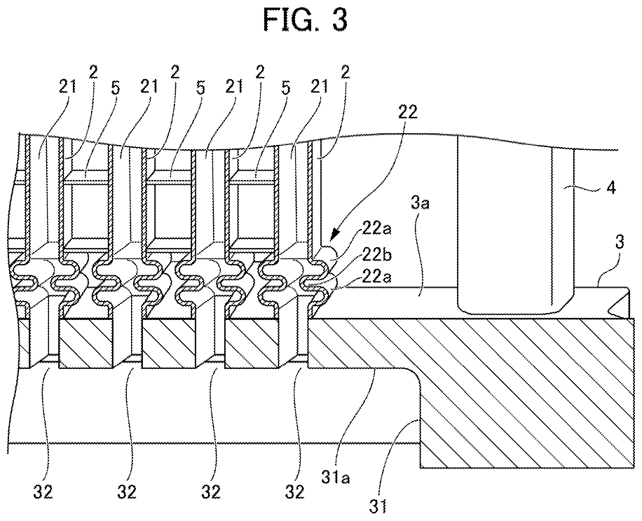

As shown in FIGS. 2, 3 and 4, each of the heat radiation parts 2 includes a displacement adjuster 22 that functions as a spring element. The displacement adjuster 22 is a part of the heat radiation part 2 and is provided integrally with the heat radiation part 2. An interior of the displacement adjuster 22 functions as each internal flow path 21 of the heat radiation part 2, and the coolant can flow through the interior.

The displacement adjuster 22 is elastically deformed like the spring element when the heat radiation part 2 is thermally expanded and displaced. Specifically, two frame bodies 3 and 3 are held at the regular interval by the supports 4, and hence when the heat radiation part 2 extends in a length direction due to the thermal expansion displacement, the displacement adjuster 22 is elastically displaced in a contracting direction, to absorb an extended length of the heat radiation part 2. When the heat radiator part 2 contracts in the length direction, the displacement adjuster 22 is elastically displaced in an extending direction, to compensate for contraction of the heat radiation part 2. Therefore, the extension and contraction of the heat radiation part 2 suppresses stress concentration on a boundary between the heat radiation part 2 and the frame body 3.

The displacement adjuster 22 of the present embodiment is formed into a bellows shape by alternately arranging, in the length direction of the heat radiation part 2, an outer curved portion 22a in which a part of a wail of the heat radiation part 2 is curved outward over an entire circumference of the heat radiation part 2 and an inner curved portion 22b in which a part of the wall of the heat radiation part is curved inward. However, the displacement adjuster 22 may be formed into any shape, provided that the displacement adjuster is elastically deformed in the length direction of the heat radiation part 2 and can absorb and compensate for the thermal expansion displacement of the heat radiation part 2, and the shape is not limited to the bellows shape. The displacement adjuster 22 may have various shapes such as a shape in which the wall of the heat radiation part 2 is spirally curved along a circumferential direction. The outer curved portion 22a and inner curved portion 22b may have any cross-sectional shape such as an elastically deformable shape, and examples of the shape may include a substantially triangular shape, a substantially rectangular shape, and the like.

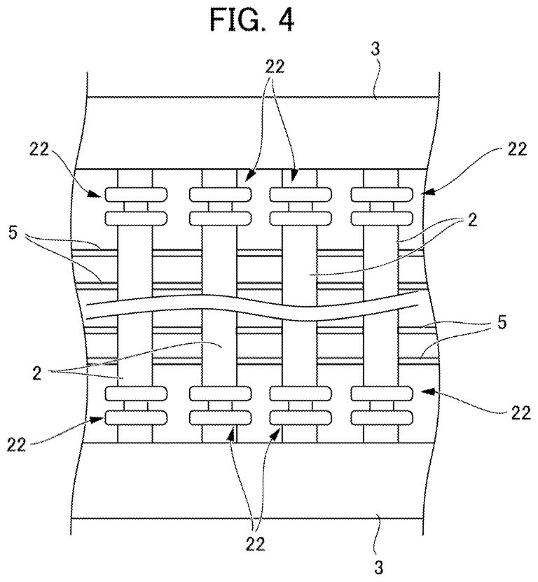

As shown in FIG. 4, the displacement adjuster 22 of the present embodiment is arranged at each of both ends of the heat radiation part 2. The thermal expansion displacement of the heat radiation part 2 can be absorbed in the vicinity of the boundary between the heat radiation part 2 and the frame body 3, so that an effect of suppressing stress concentration on the boundary between the thin heat radiation part 2 and the thick frame body 3 can be further enhanced, and cracks can be effectively prevented from being generated at the boundary. When the coolant passes through the displacement adjuster 22 near an inlet of the internal flow path 21, turbulence occurs along an overall length of the internal flow path 21, and hence heat exchange efficiency of the heat radiation part 2 is also improved.

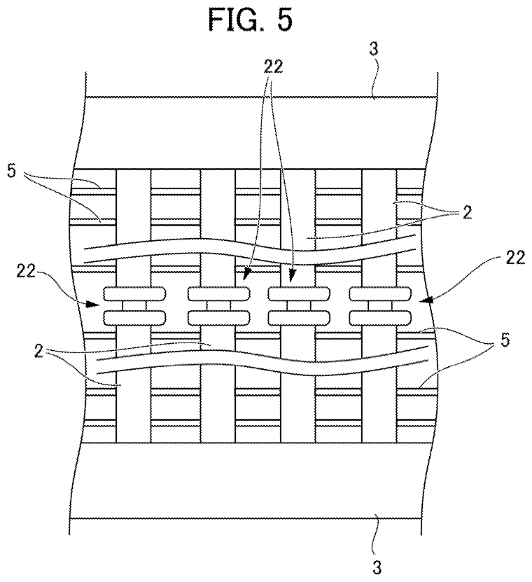

The displacement adjuster 22 is not limited to those provided at both ends of the heat radiation part 2 from the viewpoint of absorbing the thermal expansion displacement of the heat radiation part 2 and may only be provided on at least a part of the heat radiation part 2. For example, as shown in FIG. 5, each of the displacement adjusters 22 may be provided at one position in a center in the length direction of the heat radiation part 2. Although not shown, the displacement adjusters 22 may be arranged at three or more positions, spaced apart in the length direction of the heat radiation part 2. Furthermore, although not shown, the heat radiation part 2 may include a displacement adjuster extending along the overall length in the length direction.

The radiator 1 is an integrally formed product formed by integrally forming the heat radiation part 2 including the displacement adjuster 22, the frame body 3, the support 4, and the heat transfer fin 5. The compact and lightweight radiator 1, which is the integrally formed product, can be easily manufactured.

The radiator 1 including the integrally formed product can be manufactured by additive manufacturing including additively manufacturing the heat radiation part 2 including the displacement adjuster 22, the frame body 3, the support 4, and the heat transfer fin 5 by use of the same metal material (powder metal, metal wire or the like). Specifically, the radiator 1 is manufactured by the additive manufacturing including forming the displacement adjuster 22 that functions as the spring element integrally with the heat radiation part 2 and forming the frame body 3 integrally with each of both ends of the heat radiation part 2. According to this manufacturing method, the heat radiation part 2, the frame body 3, the support 4 and the heat transfer fin 5 can be easily integrally formed using a 3D printer. As the metal material, a metal material having excellent thermal conductivity, such as an aluminum-based or copper-based metal material, can be used.

In the additive manufacturing by use of the 3D printer, for example, when using the powder metal as the metal material, the radiator 1 is three-dimensionally additively manufactured by repeating a step of irradiating, with a laser or electron beam as a heat source, powder metal covering a powder metal base plate, to melt and coagulate a portion to be manufactured, and a step of moving the base plate to cover the base plate with a new powder metal. Specifically, the radiator 1 is three-dimensionally additively manufactured from one frame body 3 toward the other frame body 3 along the length direction of the heat radiation part 2. According to this additive manufacturing, the high-quality radiator 1 can be easily manufactured, in which the heat radiation part 2 integrally includes the displacement adjuster 22 and the boundary between the heat radiation part 2 and the frame body 3 is continuous.

In short, according to the radiator 1 in accordance with the present embodiment, the following effects are exhibited. Specifically, the radiator 1 that is a heat exchanger includes the heat radiation part 2 having the opened outer surface and the frame bodies 3 provided at both ends of the heat radiation part 2. The heat radiation part 2 includes the displacement adjuster 22 that functions as the spring element. According to this configuration, thermal expansion displacement of the heat radiation part 2 can be absorbed by elastic deformation of the displacement adjuster 22, so that stress concentration on the boundary between the heat radiation part 2 and the frame body 3 due to temperature change can be suppressed, and the high-quality radiator 1 in which any cracks are not generated can be provided.

In the radiator 1, the heat radiation part 2 is provided continuously with the heat radiation part connecting surface 3a of the frame body 3. The displacement adjusters 22 are arranged at both ends of the heat radiation part 2. According to this configuration, since the thermal expansion displacement of the heat radiation part 2 can be absorbed in the vicinity of the boundary between the heat radiation part 2 and the frame body 3, the effect of suppressing the stress concentration on the boundary can be further enhanced.

In the radiator 1, the displacement adjuster 22 is formed into the bellows or spiral shape by curving the wall of the heat radiation part 2. According to this configuration, the displacement adjuster 22 capable of absorbing the thermal expansion displacement of the heat radiation part 2 can be easily formed.

In the radiator 1, the heat radiation part 2 and the frame body 3 are integrally formed as the integrally formed product. According to this configuration, the compact and lightweight radiator 1 can be easily manufactured.

In the radiator 1, the heat radiation part 2 and the frame body 3 are formed as the integrally formed product by the additive manufacturing by use of the same metal material. According to this configuration, the heat radiation part 2 and the frame body 3 can tee easily integrally formed using the 3D printer.

The method of manufacturing the radiator 1 of the present embodiment is a method of manufacturing the radiator including the heat radiation part 2 having the opened outer surface, and the frame bodies 3 provided at both ends of the heat radiation part 2. The method includes, by the additive manufacturing by use of the metal material, forming the displacement adjuster 22 that functions as the spring element integrally with the heat radiation part 2, and forming the frame bodies 3 integrally with both ends of the heat radiation part 2. According to this configuration, the radiator 1 of high quality can be easily manufactured using the 3D printer, in which the thermal expansion displacement of the heat radiation part 2 can be absorbed by the elastic deformation of the displacement adjuster 22 and the stress concentration on the boundary between the heat radiation part 2 and the frame body 3 due to temperature change can be suppressed.

In the above embodiment, the radiator 1 of a vehicle is described as the example of the heat exchanger, but the heat exchanger according to the present invention is not limited to the radiator of the vehicle and can be widely applied to a device for cooling or. heating a medium of gas or liquid.

### EXPLANATION OF REFERENCE NUMERALS

1 radiator

2 heat radiation part

3 frame body

3a heat radiation part connecting surface

22 displacement adjuster

What is claimed is:

1. A heat exchanger comprising: a heat radiation part having an opened outer surface, and frame bodies provided at both ends of the heat radiation part,
wherein the heat radiation part includes a displacement adjuster that functions as a spring element.

2. The heat exchanger according to claim 1, wherein the heat radiation part is provided continuously with one surface of each of the frame bodies, and
the displacement adjuster is arranged at each of both ends of the heat radiation part.

3. The heat exchanger according to claim 1, wherein the displacement adjuster is formed into a bellows or spiral shape by curving a wall of the heat radiation part.

4. The heat exchanger according to claim 1, wherein the heat radiation part and the frame bodies are integrally formed as an integrally formed product.

5. The heat exchanger according to claim 4, wherein the heat radiation part and the frame bodies are formed as the integrally formed product by additive manufacturing by use of the same metal material.

6. A method of manufacturing a heat exchanger comprising a heat radiation part having an opened outer surface, and frame bodies provided at both ends of the heat radiation part,
the method comprising, by additive manufacturing by use of a metal material, forming a displacement adjuster that functions as a spring element integrally with the heat radiation part, and forming the frame bodies integrally with both ends of the heat radiation part.
